(19) United States
(12) Patent Application Publication
(10) Pub. No.: US 2025/0295046 A1
(43) Pub. Date: Sep. 25, 2025

(54) Harvester Header Tillage Attachment

(71) Applicant: Tanner Schoff, Walnut, IL (US)

(72) Inventor: Tanner Schoff, Walnut, IL (US)

(21) Appl. No.: 18/611,371

(22) Filed: Mar. 20, 2024

(51) Int. Cl. A01B 49/04; A01B 35/28; A01D 43/12

(52) U.S. Cl. CPC A01B 49/04; A01B 35/28; A01D 43/12

(57) ABSTRACT

The present invention is a harvester header attachment designed to slice crop residue and till soil as a harvester is harvesting a field of crops. The present invention is a series of tillage devices attached to the bottom side of a harvester's header. As the harvester moves through a field of crops, the tillage devices spin on a bearing and cut into the crop's stalks, leaves, and root balls, tilling the standing crop residue. The present inventions will have down pressure from the weight of the harvester's header causing them to cut into the soil profile a couple of inches. This will allow the present invention to act as a tillage tool. With both the crop residue being punctured and the soil being tilled, the present invention will incorporate the soil with the crop residue and have many benefits for farmers' fields and equipment.

### BACKGROUND OF THE INVENTION

The present invention (“Harvester Header Tillage Attachment,” “tillage assembly”) is a dual-purpose product to cut and size crop residue as well as minimally till the ground. The present invention is a product that greatly increases the efficiency of how we conserve soil and gain soil health for future generations. The present invention is a harvester header attachment that allows a harvester to be simultaneously a harvester and a tillage tool. The present invention, immediately after a crop plant is harvested, cuts into the crop's residue from the top of the stalk all the way down to the root ball below the ground. The present invention also cuts a few inches down into the soil profile, resulting in a tillage application as well. This patent idea will revolutionize the harvester header by making it a dual-purpose piece of machinery, harvesting crops and tilling the ground all at the same time.

Products on the market previously and currently that, like the present invention, are units mounted on the underside of headers are designed only to reduce tire wear by bending crop residue. While the present invention is also a unit mounted on the underside of a header, it is different from current products in that it further reduces tire wear by not only bending the stalks over but also slicing the stalks, while also tilling the soil to incorporate soil with the residue. This practice does a much better job of knocking down and pulverizing residue to reduce tire wear on equipment. Also, with the tillage function the residue is incorporated into the soil, causing the residue to be more easily opened up to allow microorganisms in the soil to infiltrate and feed on the residue, and in turn breaking down that residue and nourishing the soil faster than occurs when stalks are merely bent over. Additionally, the present invention can eliminate the need for a second pass with a tractor and minimal tillage implement.

Throughout the history of agriculture, farmers have faced challenges and have always looked to find sustainable solutions. Today, there are three main problems in agriculture the present invention can combat. The first is managing crop residue from high-yielding crops. Crop residue is the stalk, leaf, and roots left out in the field from crops being grown. Crop residue needs to be broken down in order for the next year's crop to have a good seed bed. Also, breaking down residue puts nutrients back in the soil for next year's crop. The second is soil erosion. Farmers are concerned with preserving soils on farms and are looking for minimal tillage options to combat soil erosion. The third is reduction of carbon output from farms. The government in multiple countries are strongly encouraging farmers to reduce carbon output from farms. Each time the soil is tilled conventionally, carbon is released into the atmosphere causing a number of environmental concerns. The present invention allows a farmer to minimum till with a combine so less carbon is released into the atmosphere. The present invention is a solution that is an answer to all three of these problems.

In the past, farmers managed residue with conventional tillage. This practice mixes soil with crop residue, which starts the decaying process. Today we know this is not a sustainable practice for the future of agriculture. The earth has one layer of topsoil, and if we continue to practice conventional tillage, the top layer of soil will continue to be eroded by wind and water. In recent years, some farmers have started to realize how detrimental deep tillage is to their fields and the environment, and appropriate changes have been made. Practices such as no till, strip till, and vertical till have been three big changes to tillage practices for farmers in recent years. No till is the practice of planting into conditions where no tillage was done. Strip tillage is the practice of tilling a small strip in between the previous crop rows and planting into that strip. Vertical tillage is a practice designed to size, chop, and slice crop residue, while only cutting into the ground a few inches. These practices have been greatly beneficial to reducing erosion of fields, as well as keeping organic matter and carbon within the soil, leading to much better soil health and a healthier environment. Not only are farmers changing tillage practices to preserve soils, but the United States government is forcing farmers to practice reduced tillage due to the Carbon Farming Initiative, which is an essential part of the Emissions Reduction Fund and helps farmers earn carbon credits by making changes to land use or management practices to store carbon, reduce greenhouse gas emissions, or both. To comply with this program, farmers are being forced to change tillage practices to reduced tillage practices so carbon can be contained in the soil and not released into the atmosphere. While some farmers today are taking much more precaution with their soils, a large challenge still lies ahead. How will farmers manage all of the crop residue on top of the soil without doing the deep tillage? In addition, the yields of crops being grown today have nearly tripled in bushels per acre compared to 70 years ago, which means today's farmers are having to deal with much more crop residue.

The present invention is a solution to the issues laid out here. First, the present invention creates faster residue decay and therefore faster soil enrichment. When practicing no till, standing residue is left in the field as is after harvest. That crop residue can be there for multiple years because it has not been cut up at all. As an attachment to a harvester's header, the present invention cuts into that residue as part of the act of harvesting and pulverizes the residue, acting as a minimal tillage tool, allowing it to break down and decay at a much faster rate. When cutting and sizing residue it allows microorganisms to infiltrate and start feeding on the residue, breaking it down more quickly than if the residue were merely left lying on the soil in a more intact form when no-till practices are used. This in turn keeps soils healthier because the microorganisms have more accessible food to feed on more easily. This will help ensure a clean seed bed for next year's crop.

Second, the present invention saves farmers time and money, as the present invention is attached to a harvester's header, so there is no need to do a second pass with different equipment to address the residue. This saves on fuel, time, labor, and tractor wear and tear. Also, the farmer using the present invention has no need for owning an extra minimal tillage implement, which is expensive.

Third, the present invention reduces tire wear. A significant problem with crop residue is the tire wear it causes on agricultural equipment. After harvest, small stalks remain sticking up out of the ground, which can cause wear on the tires of tractors and implements driving over them in the fields. The present invention eliminates this problem since it is cutting through stalks/roots and making them weak, brittle, and flattening them. This leaves a nice, flat surface for those tractors and implements to go over with significant reduction in tire wear.

Fourth, The present invention improves water infiltration into the ground and reduces soil runoff from excessive rainfall by cutting a seam into the soil as it processes the residue.

There are currently some alternative products that attach to a header to solve part of these problems. The two main products are stalk stompers and stalk devastators. A stalk stomper is a spring-loaded paddle that drags on top of the crop residue, which causes the residue to bend over at ground level. A stalk devastator is a rolling tube that like a stalk stomper also rolls over the crop residue, resulting in the stalks being bent over. These two products do a decent job with laying the crop over, but the remaining crop residue still has a tendency to stand back up over time, causing additional wear on tires on machinery that must drive over the residue, and is not cut up or pulverized, causing the residue to take longer to break down and be available as a food source for microorganisms to nourish the soil. The difference with the present invention is that in addition to bending the crop residue over, it pulverizes and cuts it and turns up some soil into that cut up residue, resulting in soil and crop residue mixing together, and speeding up the process of that crop residue breaking down. This practice makes the crop residue much more brittle and weakens the rigid corn stalk sticking up out of the ground. There is also vertical tillage equipment, but use of that equipment requires a second pass with different machinery after harvest is completed. The present invention is different in that it combines vertical tillage with the harvest pass, allowing for savings on additional equipment as well as wear and tear on equipment, and increasing farming efficiency.

### BRIEF DESCRIPTION OF DRAWINGS

FIG. 1 is an angled view of the right side of the preferred embodiment of the present invention.

FIG. 2 is a front view of the preferred embodiment of the present invention.

FIG. 3 is a view of the right side of the preferred embodiment of the present invention.

FIG. 4 is an angled view of the left side of the preferred embodiment of the present invention with a wavy blade.

FIG. 5 is an angled view of the left side of the preferred embodiment of the present invention with a flat blade.

FIG. 6 is an angled view of the left side of the preferred embodiment of the present invention with a cultivator sweep

FIG. 7 is an angled side view of the preferred embodiment of the present invention attached to a harvester header.

FIG. 8 is a side view of the preferred embodiment of the present invention attached to a harvester header.

FIG. 9 is an angled back view of the preferred embodiment of the present invention attached to a harvester header.

FIG. 10 is an angled back view of the present invention attached to a harvester header through use of a mounting bracket on the header.

FIG. 11 is a top view of the preferred embodiment of the present invention attached to the harvest headers of a harvesting machine.

FIG. 12 is a back view of the preferred embodiment of the present invention with an electric source for adjustment attached.

### LEGEND FOR DRAWINGS

1. Attachment base
2. Angle adjustment cutout
3. Tillage arm
4. Tillage depth adjustment bracket
5. Adjustment cutout
6. Adjustment bolt
7. Attachment assembly
8. Tillage attachment
9. Coulter
10. Bearing dome
11. Coulter bolt
12. Bearing plate
13. Spindle bolt
14. Bearing housing
15. Buttress
16. Pivot bolt
17. Spindle bracket
18. Disk
19. Cultivator sweep
20. Corn head
21. Tillage assembly
22. Rear mounting bracket
23. Row crop plant
24. Adjustment power cylinder
25. Power line
26. Power cylinder bracket
27. Lower bracket

### DETAILED DESCRIPTION

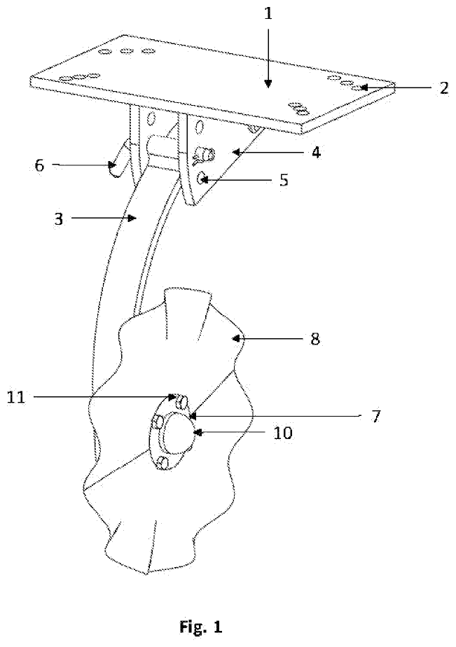

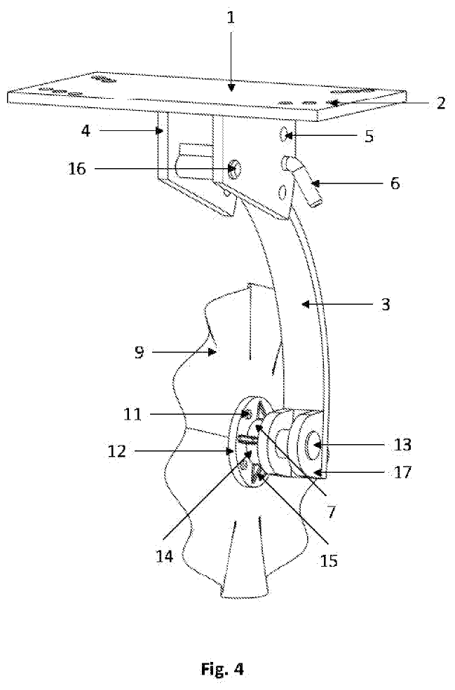

The present invention is ideally made of steel parts, though other strong materials suitable for heavy agricultural use and of sufficient weight to absorb the impact of rocks and other hard objects in the field may be used. As depicted in FIG. 1, the attachment base (1) for attaching the present invention to a harvester header is a rectangle or other oblong shape, ideally made of half-inch-thick steel, with angle adjustment cutouts (closed circles as seen in FIG. 1) (2) on each “short end” of the bracket where bolts can be inserted to attach the present invention to the harvester header. As depicted in FIG. 4, attached perpendicularly left of center to the underside of the attachment base by welds and parallel to each other, separated by sufficient space to insert one end of the tillage arm (3) are two parts forming the tillage depth adjustment bracket (4). There is a hole at the front of each part of the tillage depth adjustment bracket through which a pivot bolt (16) is threaded to attach the tillage arm, which has a corresponding hole in one end through which the bolt is passed. As seen in FIG. 1, at the back of each part of the tillage depth adjustment bracket are arm adjustment cutouts (5) arranged such that an adjustment bolt (6) can be passed through one arm adjustment cutout in one part of the tillage depth adjustment bracket, over the tillage arm such that the adjustment bolt limits the angle to which the tillage arm can be raised, and through a corresponding arm adjustment cutout in the other part of the tillage depth adjustment bracket and secured, such as with a pin, to position the tillage arm for the best angle for the height and pitch of the crops to be harvested. The adjustment bolt can be spring-loaded to be pulled back and released easily. The other end of the tillage arm has a perpendicular spindle bracket (17) through which a spindle bolt (13) slides to attach the tillage arm to an attachment assembly (7). The preferred embodiment of an attachment assembly is as follows: a cylindrical bearing housing (14) containing lubricated bearings and having a cutout core; a bearing plate (12); a bearing dome (10) that has a flat lip extending out from its bottom, forming a disk (18); and coulter bolts (11) to secure the disk to the bearing plate once a coulter (8) is placed between them. The bearing housing is attached to the bearing plate through welds and may also have buttresses (14) welded to the bearing housing and bearing plate for strength and stability. The spindle bolt slides through the cutout core of the bearing housing, then slides through a hole in the center of the bearing plate attached to the opposite side of the bearing housing, then slides through a hole in the center of the coulter and is secured with a nut. The bearing dome is placed over the center of the coulter blade opposite the bearing housing. The bearing plate, coulter, and disk are secured together by coulter bolts inserted through corresponding holes in the bearing plate, coulter, and disk. The bearing housing contains lubricated bearings and allows the attached coulter to spin freely around the spindle bolt.

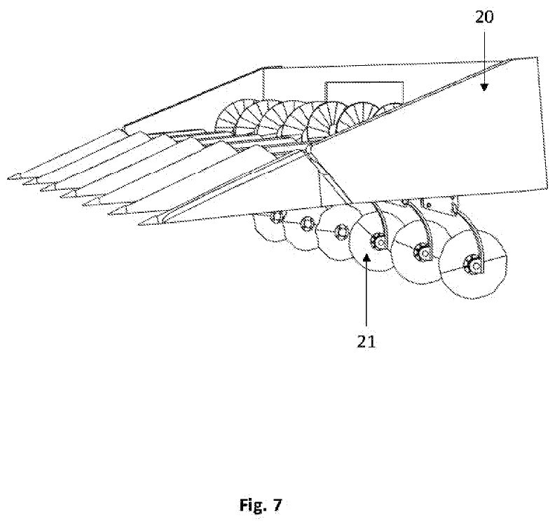

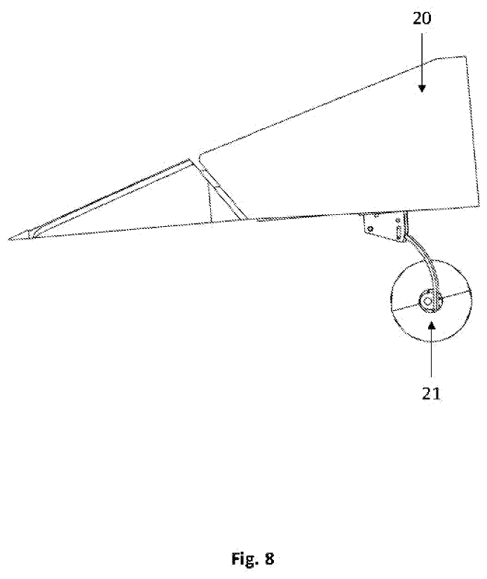

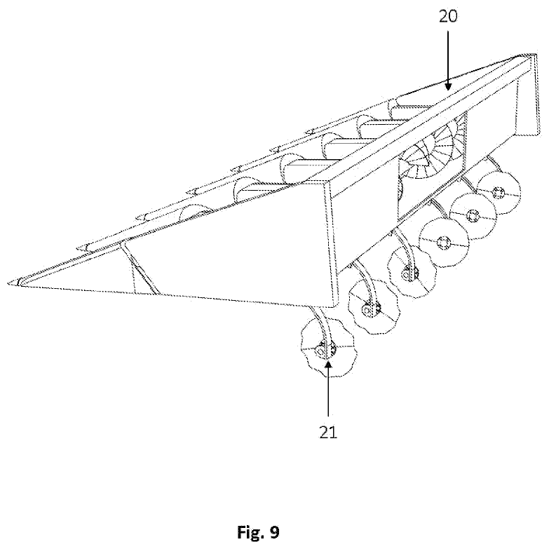

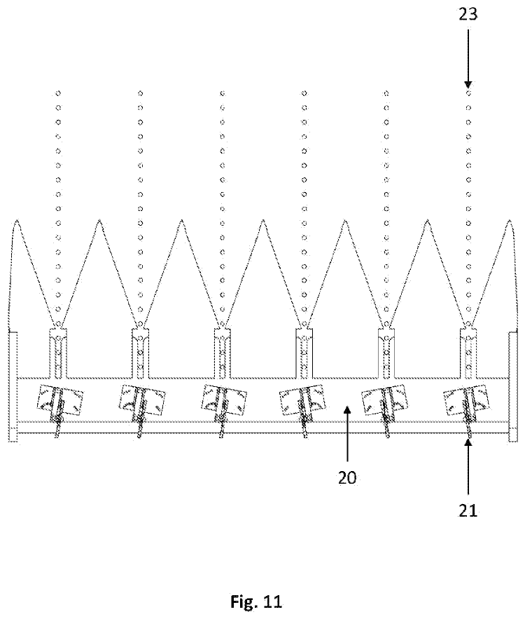

The present invention is attached to the harvester header of a harvesting machine, as shown in FIG. 7 through FIG. 11. The harvester machine harvests the row crop plant (23), then the present invention processes the row crop plant residue. The present invention, being made of steel or other strong material, is heavy enough such that the coulter blade sinks into the field a few inches, slicing a seam into the soil as it spins. When it contacts crop residue, such as a stalk, the coulter blade slices through and pulverizes the residue, pushing part of the pulverized residue into the seam in the soil.

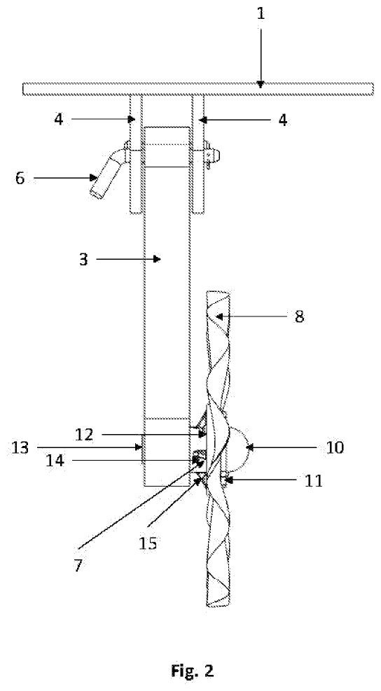

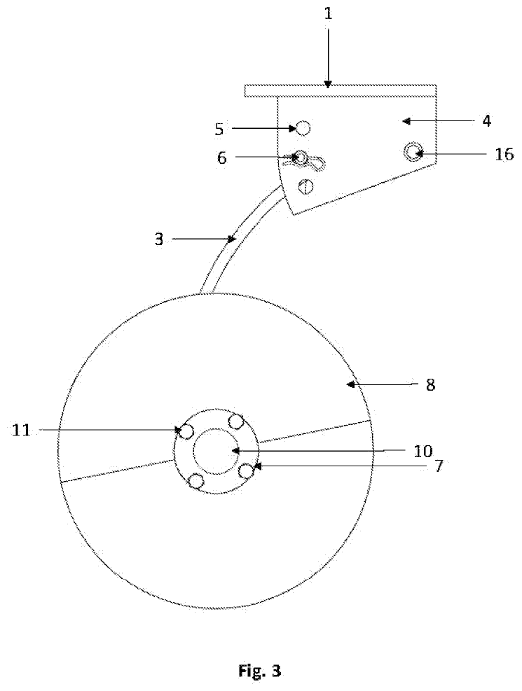

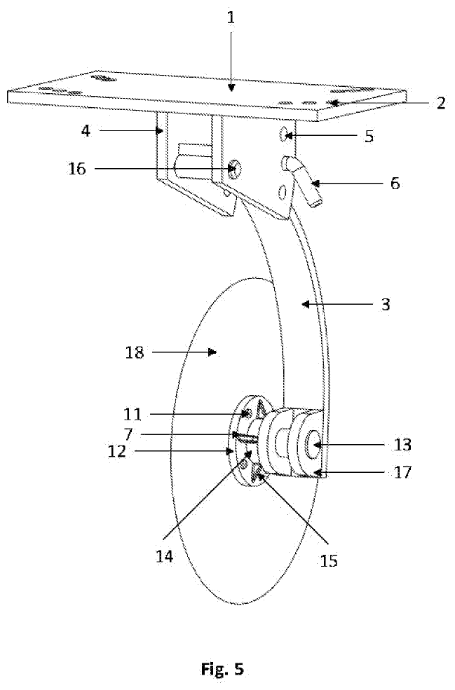

The preferred shape of the coulter blade is a wavy shape, as shown in FIG. 1, FIG. 2, and FIG. 4. A potential issue is being able to directly hit the corn stalks with the coulter. On a side hill or when there is GPS drift (such that the combine isn't tracking completely straight on the row) the coulter may become offset. To combat this, having a wavy coulter blade, which has a wider footprint than a flat blade (shown in FIG. 3 and FIG. 5), will work the best, even if the combine is tracking off a couple inches left or right. There are multiple types of coulter styles on the market today: plain flat coulter blades used for shallow cuts with little tilling action, notched coulter blades that provide excellent grip in heavy soil and high residue conditions, bubble coulter blades that offer aggressive soil movement for residue management and excellent tilling action in almost any soil conditions, fluted coulter blades used for residue management and soil refinement with little soil disturbance, concave coulter blades that create extreme tillage action, and wavy coulter blades that offer aggressive soil movement for residue management and excellent tilling action in almost any soil conditions. The wavy coulter blade option is preferred for the present invention because it has a wider footprint than the other styles of coulter blade and thus would have a greater chance of chopping the standing stalks with variance in the header's left and right position. This choice of best blade style allows a farmer to use whichever style of coulter blade the farmer sees best fit for his operation.

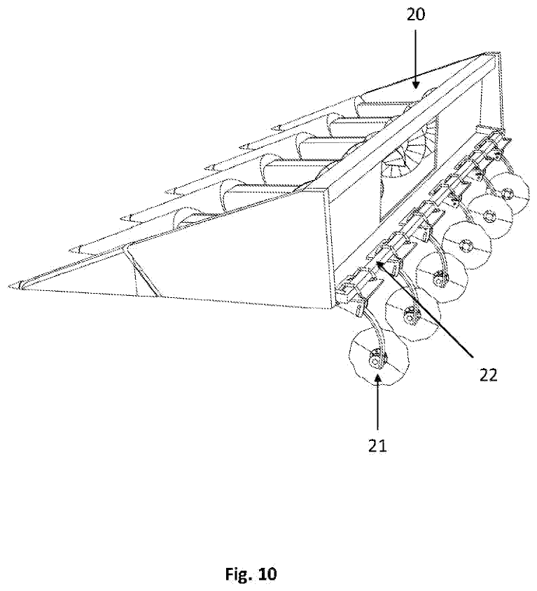

Additional embodiments for attaching the present invention to the harvester headers are possible. On newer corn heads, there are factory-made threaded holes that the current stalk stompers attach to. On certain models of headers, the stalk stompers can be removed, and the invention attached in their place by threading bolts through the cutouts in the attachment base into the existing holes in the heads. On older headers, there are no such bolt holes in the bottom of the head. In this situation, the present invention can be attached, rather than through bolts threaded through the cutouts in the attachment base, by adding a long mounting bracket (22) along the bottom of the harvester head, then attaching the tillage assembly (21) to the mounting bracket with a U-bolt assembly, as shown in in FIG. 10.

An additional embodiment is to add a spring-loaded device to the coulters. A spring would replace the pin that holds the arm in a static position. This would allow the coulter to have range of motion in its action as its running in the field. A harvester's header stays relatively close to the same height going through a field, but due to terrain, side hills, or deep cuts in a field, the header can adjust in height or pitch. With spring loaded units, the coulter blade position can float up or down based on how high or low the header gets. This would ensure consistent sufficient pressure from the coulter blade to the ground as a head raises and lowers. This embodiment would also address rocks or other heavy residue that may pile up in front of the coulter by allowing the coulter the flexibility to raise up over those obstacles.

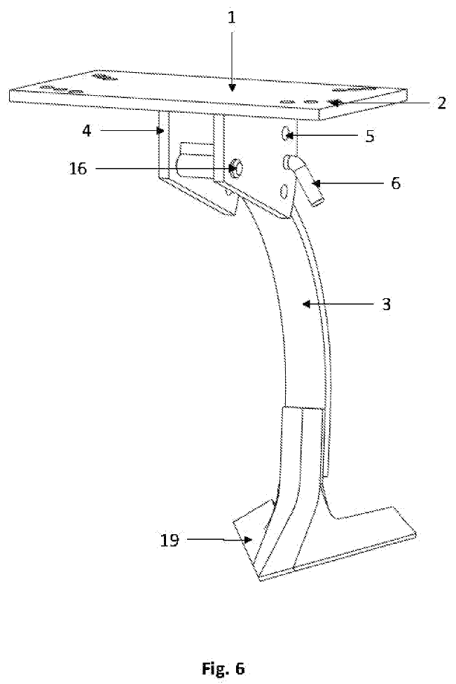

Another embodiment is, instead of the tillage arm attaching to an attachment assembly and coulter, the tillage arm is attached to a cultivator sweep (19), as shown in FIG. 6.

The preferred embodiment describes the present invention configured for managing corn crop residue. FIG. 7 through FIG. 10 show the tillage assembly (21) attached to a corn head (20). The present invention may be adapted for a wide variety of other headers, such as wheat headers, bean platforms, silage choppers, and sunflower headers.

The preferred embodiment contemplates attaching a single tillage assembly for each row. For example, most corn heads are set up on 20- or 30-inch spacing; therefore, the tillage assemblies would be mounted 20 or 30 inches apart. Additional coulter blades could be added if there is a need to do more aggressive tillage. This may include a multi-blade configuration on each tillage assembly, or the addition of multiple tillage assemblies staggered across the width of the header in between the crop rows.

Another embodiment for more aggressive tillage and widening the footprint to hit residue is to change the angle of the coulter blade. The larger the angle, the more aggressive tillage becomes. The angle can be adjusted to fit the specific crop conditions and desired soil disturbance.

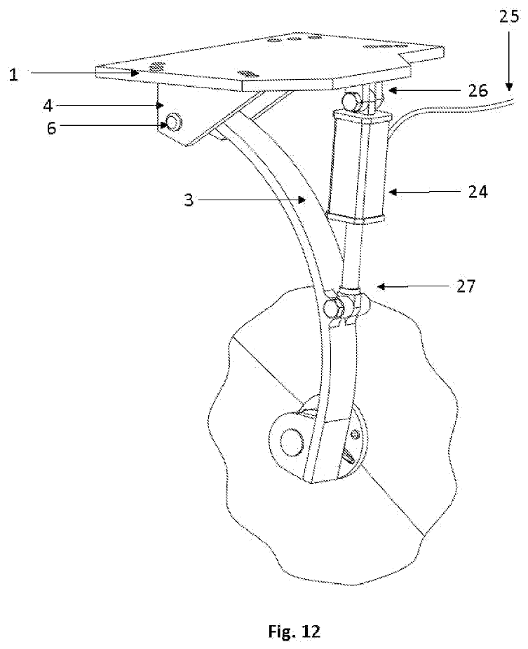

Combines usually detach their headers and put them on a header cart when they go from one field to the next. There is enough clearance to put the header on a cart with a tillage assembly on, but it may be beneficial to have a quick adjustment where the tillage assemblies can be folded up or detached. Another example in which it would be beneficial to have them fold up or detach quickly is if a farmer gets into a situation in which the field is muddy or unfit for the use of them. The farmer could quickly set the tillage assembly in a position where they would not be getting used and the field can be harvested without using the tillage assemblies by setting the position of the adjustable arm such that the tillage assemblies are out of the way. This can be accomplished by pulling the adjustment bolt out, sliding the tillage arm up, and reinserting the adjustment bolt into the upper adjustment cutout holes. Alternatively, in the case of a spring-loaded configuration, the farmer could use the quick release pin to detach any tillage assemblies that may need to be removed. The tillage assembly also can be adjusted within the cab of a harvester by the means of power. This will allow an operator to adjust height, pressure, pitch, angle, and working position of the unit from within the cab. This is possible by using the means of hydraulic power, electrical power, or pneumatic power. Having this ability allows for on-the-go adjustments to be made and allows working positions to be changed quickly and efficiently without having to adjust all units individually by hand. FIG. 12 shows such an alternative embodiment, with an adjustment power cylinder (24) and power supply line (25) attached. In addition to the adjustment bracket, which need not have the adjustment cutouts, there is an additional power cylinder bracket (26) that attaches the adjustment power cylinder to the attachment plate, and a lower bracket (27) on the tillage arm. The power supply line would be connected to a controlling mechanism in the harvester cab.

1. A method of simultaneously harvesting row crops and practicing tillage, the method comprising: providing a harvesting machine; attaching a row crop header to said harvesting machine; attaching a tillage assembly to each header row on said row crop header; operating said harvesting machine to harvest one or more rows of the crop to be harvested; and said tillage assembly engaging in tillage by slicing through and/or pulverizing crop residue, tilling said crop residue into the soil.

2. The method of claim 1, further comprising said tillage assembly being adjustable to allow for changing the pitch, angle, and depth of said tillage assembly and folding said tillage assembly out of the way when not needed so detachment is not necessary.

3. A system for simultaneously harvesting row crops and practicing minimum tillage, the system comprising: a harvesting machine; a row crop header attached to said harvesting machine; a tillage assembly attached to each header row on said row crop header; each of the one or more said tillage assemblies being capable of minimum tillage by knocking over and slicing and/or pulverizing crop residue and embedding some of said residue into the soil.

4. The system of claim 3, in which said tillage assembly is adjustable to allow for changing the pitch, angle, and depth of said tillage assembly and folding said tillage assembly out of the way when not needed so detachment is not necessary.

5. A tillage assembly attached to each of one or more row crop headers attached to a harvesting machine, said tillage assembly comprising:
An attachment base for attaching to one crop header and having angle adjustment cutouts for adjusting the angle of attachment to said crop header;
an attachment assembly;
a tillage attachment, attached to said attachment assembly, capable of minimum tillage slicing through and pulverizing row crop residue remaining after harvesting said row crop, returning some of said sliced and pulverized row crop residue into the soil in a seam sliced into the ground by said tillage attachment, and bending over any crop residue not sliced or pulverized;
a tillage arm connecting said attachment base and said attachment assembly; and
a tillage depth adjustment bracket attached to the bottom of said attachment base and having arm adjustment cutouts, through which an adjustment bolt slides to attach said tillage arm to said attachment base, said arm adjustment cutouts allowing for adjusting the angle and depth of said tillage arm.

6. The tillage assembly of claim 5, further comprising additional tillage attachments attached to said attachment assembly to create a wider footprint of operation.

7. The tillage assembly of claim 5, further comprising a quick-release system for said adjustment bolt for fast adjustment and detachment of said tillage arm.

8. The tillage assembly of claim 5, in which said tillage adjustment bracket is replaced by an adjustment power cylinder and power supply line attached to a controlling mechanism in the harvester cab.
